(19) United States
(12) Patent Application Publication
(10) Pub. No.: US 2026/0051217 A1
(43) Pub. Date: Feb. 19, 2026

(54) SYSTEMS AND METHODS FOR GAME TERMINAL FILL OPERATIONS

(71) Applicant: Savvy Dog Systems, LLC, Duluth, GA (US)

(72) Inventors: Michael Pace, Duluth, GA (US); Dan Miser, Duluth, GA (US); Glen Carter, Duluth, GA (US)

(21) Appl. No.: 19/296,103

(22) Filed: Aug. 11, 2025

Related U.S. Application Data
(60) Provisional application No. 63/682,598, filed on Aug. 13, 2024.

(51) Int. Cl. G07F 17/32

(52) U.S. Cl. CPC G07F 17/3225; G07F 17/3241

(57) ABSTRACT

Systems and methods to enable fill operations are disclosed. An embodiment of a method may include initiating a fill request for continued play of one or more electronic games at the electronic gaming terminal. The method may include verifying an electronic gaming terminal PIN and account password. The method may include, in response to verification, generating a fill request. The method may include encrypting and transmitting the fill request to a fill management system from an electronic gaming terminal. The method may include generating a fill code. The method may include building and encrypting a fill response including the fill code to form an encrypted fill response. The method may include transmitting the encrypted fill response from the fill generation system to the electronic gaming terminal. The method may include decrypting the encrypted fill response. The method may include applying a fill amount to the electronic gaming terminal.

### CROSS-REFERENCE

The present application claims the benefit of U.S. Provisional Patent Application No. 63/682,598, filed Aug. 13, 2024.

### INCORPORATION BY REFERENCE

The disclosure and figures of U.S. Provisional Patent Application No. 63/682,598, filed Aug. 13, 2024, are incorporated by reference herein for all purposes as if fully set forth in its entirety.

### FIELD OF DISCLOSURE

The present disclosure is generally directed generating toward game terminal fill operations and, in particular, toward securely refilling attempts or plays for a gaming terminal.

### BACKGROUND

Amusement and entertainment type electronic games, played via a gaming terminal or systems, have become very popular with the public and, as their popularity has increased, several states have legalized certain types of gaming, but under heavy regulation. For example, skill-based gaming terminals are permitted in some states. Generally, to qualify as a skill-based gaming terminal, the outcome of play during the game is controlled by the person playing the game and not by predetermined odds or random chance controlled by the gaming terminal. Some chance can be part of a skill-based game, but skill may be the predominant feature. The play on the gaming terminal involve a task, game, play, contest, competition or tournament in which the player actively participates. Other types of games may also face similar or even stricter regulation.

To ensure compliance with applicable state and/or federal laws (for example, laws relating to how total taxable income is generated and/or laws relating to gameplay limitation), a typical gaming terminal may include algorithms for adding plays. Typically, a unique passcode is utilized to add additional plays (in other words, a fill or fill operation). However, the potential for third-parties to unjustly or illegally obtain data related to a fill for a particular gaming terminal is increasing. Further, gaming terminals positioned in certain areas may not have access to suitable internet connections to complete fill operations.

### BRIEF SUMMARY

Accordingly, Applicant has recognized a need in the art for techniques, systems and methods to facilitate the requesting and obtaining of “fills” at one or more gaming terminals, and which ensure that properly identified and licensed electronic games on a gaming terminal each timely and securely receive a fill via the internet and/or via an application.

Such systems and methods may include a gaming terminal and a fill management system in communication with each other. In embodiments, the fill management system may include a fill generation system and an account management system. In other embodiments, the fill management system can be in communication with the account management system and can include, or can be configured to facilitate communication between the account management system and the fill generation system to facilitate the efficient, easy and secure fulfilment of a fill request for filling/refilling game plays at a gaming terminal.

In some embodiments, the gaming terminal may utilize a cabinet type design, including a housing with one or more displays, player controls (e.g., buttons, joysticks, touch screen, etc.), inputs such as card readers, bill acceptors, etc., and within which a game controller, which can include one or more processors configured to communicate with the terminal hardware and run a game engine for the play of one or more games, is housed. Other configurations of gaming terminals, including gaming terminals configured as table top, or linked terminals, or which can comprise mobile devices, also can be utilized with the fill management system of the present disclosure. For example, in embodiments, the gaming terminal may be included in a system that may include one or more external servers (for example, a casino player tracking server, a ticket-in-ticket out server, a progressive system server or controller, a casino management system server, a central or game server, fill system, etc.) operably connected to the gaming device. In such a system, the gaming terminals may be configured to afford players and operators the opportunity to utilize additional game functionality implemented on and/or see/access display data located on one or more of the servers.

In addition, in embodiments, a hardware device, such as a dongle, can be utilized with the gaming controller to both provide instructions and information needed to communicate with, receive and apply fills from the fill generation system. The dongle may be customized and include dedicated software and/or firmware. In embodiments, the dongle may be utilized, e.g. via insertion, to fulfill some or all of the functionality that may be required by the fill generation system to interface with and operate to provide the requested fills to a gaming terminal, and without the dongle, operation may be suspended, for example, in embodiments, the lack of a dongle interfacing with the gaming controller of a terminal can cause the fill generation system to suspend operation and the gaming terminal to be blocked from further operation.

In embodiments, the gaming terminal may initiate a fill based on a fill amount currently available on the gaming terminal and/or upon user (e.g., an operator of the game) initiation, such as by submission of a user request. In some embodiments, a fill could be initiated based on other factors in addition to or as an alternative to a remaining fill amount and/or user request, such as, for example, based on a number of plays that may be available on the gaming terminal. The gaming terminal may first generate a prompt for selection of a fill amount. In other embodiments, the fill amount may be based on a preselected fill amount or a previously set fill amount. Once the fill amount has been determined, such as via entry by the user or based on some preset or preselected fill amount, then the gaming terminal may prompt entry of a gaming terminal personal identification number (PIN) and an account password.

In some embodiments, a user or operator may manage and/or include a plurality of gaming terminals at one or more locations. In embodiments, each gaming terminal may include a unique PIN. In other embodiments, gaming terminals at selected locations may share a same PIN or a family PIN with, in embodiments, an additional identifier for differentiating among one or more of the gaming terminals at a location associated with an operator or operator account. In other embodiments, the PIN may be tied to an operator account. The account password may correspond to a user's account associated with a fill service, device, or server.

The term “fill amount” or “play,” as used herein, refers to a fill amount or amount of fill remaining on the game terminal. Fill amount or play may be used interchangeably with the terms “play amount,” “play level,” “total plays,” or “plays remaining.” The amount or value of plays may be expressed as a percentage of a full fill. Furthermore, “plays” can include a percentage of a fill remaining at the gaming terminal, and is not limited to a specific number of games that may be available to be played at the gaming terminal.

In an embodiment, the term “game credit” may refer to a number of turns a player has based on a credit amount the player has (e.g., an amount the player has paid or input for playing the game and/or based on an amount earned by the player during play of the game). In other words, in embodiments, the game credits are an amount of turns that a player may purchase and then use, while an “amount of plays” fill, or fill amount, as described above, generally will be an amount indicative of the total plays allowable on a particular gaming terminal. In embodiments, the number of game credits available to a player may be limited to the fill amount or amount of plays.

Upon entry of the PIN and account password, the gaming terminal may transmit such information to an account management system. In other embodiments, the account management system may decrypt the data prior to verification. In an embodiment, the account management system may be included with or may be a fill management system.

In some embodiments, prior to such transmission, the gaming terminal may encrypt the PIN and account password via an encryption algorithm. Upon receipt of a fill request from the gaming terminal or via a mobile device of an operator other requester, the account management system may verify the PIN and user (e.g., an operator of the game or a series of games) account. Once authenticated, the account management system can enable the request to proceed to a fill generation system.

In various embodiments, once the PIN and account password are verified, the gaming terminal may generate and transmit a fill request to a fill management system. Such a fill request may include the fill amount, as well as other data, such as user information, tax information, and/or total fills currently at all gaming terminals at a location, among other information or data. In some embodiments, prior to such transmission, the gaming terminal may encrypt the PIN and account password via an encryption algorithm. Upon receipt of a fill request from the gaming terminal, or via a mobile device of an operator other requester, the account management system may verify the PIN and user (e.g., an operator of the game or a series of games) account. Once authenticated, the account management system enables the request to proceed to a fill generation system.

In some embodiments, the fill request can be encrypted prior to being sent, for example, the gaming terminal, prior to transmission of the fill request, may encrypt the fill request. Such an encryption may utilize public keys, private keys, preloaded keys, and/or some combination thereof. In some embodiments, the fill management system may decrypt such a transmission and then generate a fill code (e.g., the fill generation system can receive the fill request and generate a fill response including the fill code). The fill management system also may encrypt the fill code, along with any other data, and transmit the encrypted data back to the gaming terminal. The gaming terminal may then decrypt the fill code and apply the fill amount to the gaming terminal.

The operations described herein may be executed with limited to no user interaction after the fill request has been initiated (e.g., the gaming terminal or a user device such as a phone, tablet, or other device). For example, a user (e.g., an operator) may request a fill and enter a PIN and account password. In yet another embodiment, the gaming terminal may generate the fill request and prompt the user to enter the PIN and account password. Further, the gaming terminal may store the PIN and account password and may automatically provide the PIN and account password.

In embodiments, gaming terminals may be located in areas with limited internet connectivity. In such examples, the process described herein may be performed via a mobile application. A user, in such examples, may prompt a fill request and, in response, the gaming terminal may generate a unique quick response (QR) code. The user may then, via an application on a mobile device, scan the QR code to generate the fill code in a manner similar to that described above. The user may then enter the fill code in the gaming terminal.

Current gaming terminals generally require substantial user interaction to perform fill operations. For example, a user typically may have to call a fill center to make a fill request, and then manually enter a fill code into the gaming terminal. The systems described herein are configured to facilitate a user to easily, securely, and quickly request and fill a system or, in other words, increase plays for a selected game corresponding to the gaming terminal, with such actions, in embodiments, being performed with limited to no user interaction. Further still, such systems may enable users to perform fill requests even when no internet or limited internet access is available. Finally, such systems and methods enable accurate tracking of fills by eliminating potential human error.

Accordingly, an aspect of the disclosure is directed to a method to enhance control and facilitate a service and easier/more efficient of a fill operation of an electronic gaming terminal. The method may include initiating a fill request for continued play of one or more electronic games at the electronic gaming terminal. In response to the fill request, the method may include generating, via the electronic gaming terminal, a prompt for selection of a fill amount. The method may include prompting, via the electronic gaming terminal, entry of an electronic gaming terminal PIN and an account password. The method may include transmitting the electronic gaming terminal PIN and the account password to an account management system. The method may include verifying, via the account management system, the electronic gaming terminal PIN and the account password. The method may include, in response to verification of the electronic gaming terminal PIN and the account password, initiating the fill request including a selected fill amount, generating, via the electronic gaming terminal, the fill request. In embodiments, fill request may include the selected fill amount. In embodiments, once the gaming terminal and account requesting the fill have been authenticated, the account management system can transmit or otherwise enable the fill request to proceed to a fill generation system. In embodiments of the method, the fill generation system can generate a fill response that can be sent directly to the gaming terminal. In embodiments, the fill response can be configured (e.g., including encryption) to associate the fill response with the gaming terminal associated with the fill request.

In some embodiments, the method also may include encrypting and transmitting the fill request to a fill management system from the electronic gaming terminal. The method may include determining an encryption key based on the previously entered electronic gaming terminal PIN. The method may include generating a fill code. The method may include building and encrypting, via the fill generation system, a fill response including the fill code and forming an encrypted fill response. The method may include transmitting the encrypted fill response from the fill generation system to the electronic gaming terminal. The method may include decrypting, via the electronic gaming terminal, the encrypted fill response. The method may include applying, via the electronic gaming terminal, a fill amount to the electronic gaming terminal.

In an aspect, the transmission of data between the electronic gaming terminal, the account management system, and the fill generation system may occur via one of a REST interface, RESTful interface, a power on self-test interface or method, an xml-based protocol (such as Simple Object Access Protocol (SOAP)), or sockets, and/or via other communication protocols or methods, as will be understood by one skilled in the art. In another aspect, the method may further include notifying the account management system that the fill response has been transmitted and verifying a successful receipt and loading of the fill response at the electronic gaming terminal by the account management system.

The fill request may include a series of random identifiers, such as, for example, a first plurality of characters, symbols, numbers, or combinations thereof. The fill response may include a second plurality of characters, symbols, numbers, or combinations thereof. Such characters, symbols, numbers, or combinations thereof, can be used for encryption and decryption of the fill request and/or the fill response.

Another aspect of the disclosure is directed to a method to enhance control of a fill operation of an electronic gaming terminal. The method may include, in response to selection of a fill request via a menu displayed via an electronic gaming terminal, generating a request to input a personal identification number (PIN) and a user password. The method may include transmitting the PIN and the user password to an account management system for verification. The method may include, in response to reception of the verification, generating a fill request, the fill request including a fill amount and the PIN, in embodiments, and transmitting the fill request to a fill generation system from the electronic gaming terminal. The method further may include, in response to reception of the fill request, generating a fill response that may be transmitted directly to the associated gaming terminal from the fill generation system.

In some embodiments the fill response may be encrypted. In such embodiments the method additionally may include decrypting the encrypted fill response with a shared key corresponding to an encryption key of the fill generation system and applying a fill amount to the electronic gaming terminal based on a fill code included in the encrypted fill response.

Another aspect of the disclosure is directed to a method to enhance control of a fill operation of an electronic gaming terminal. The method may include, in response to reception of a PIN and an account password, verifying the PIN and password and transmitting a verification to a sending electronic game terminal to prompt submission of an encrypted fill request. The method may include, in response to reception of the encrypted fill request from the electronic gaming terminal, decrypting the encrypted fill request to form a decrypted fill request and determining a fill response based on a payload in the fill request. The fill response may include a fill code. The fill code may indicate a fill amount for the electronic gaming terminal. The method may include encrypting the fill response via the encryption key to form an encrypted fill response. The method may include transmitting the encrypted fill response to the electronic gaming terminal.

Another aspect of the disclosure is directed to a system to enhance control of a fill operation of an electronic gaming terminal. The system may include one or more processors and a computer-readable storage medium, coupled with the one or more processors, comprising instructions that when executed by the one or more processors, in response to reception of an internet fill request from an electronic gaming terminal or other fill request, such as via an application initiated by scanning a QR code, request a personal identification number (PIN) and an account password from the electronic gaming terminal. The instructions may, when executed by the one or more processors, verify an account and the electronic gaming terminal based on the PIN and the account password. The instructions may, when executed by the one or more processors, in response to verification of the account and reception of a fill request, generate a fill response including a fill code based on data indicative of a fill amount included in the fill request.

In some embodiments, the fill request and/or the fill response each can be encrypted. For example, in embodiments, the fill response could be encrypted with a shared key to form an encrypted fill response, that is directable by a gaming terminal having the shared key.

In some embodiments, the instructions may, when executed by the one or more processors, in response to reception of a fill request generated via an application based on a scan of a QR code at an electronic gaming terminal, the application can be launched or initiated by scanning a QR code associated with the electronic gaming terminal, and can read the scanned QR code and generate and send a QR code fill request (which also can be referred to as a QR code payload request) to the server. In embodiments, the QR code fill request generated by the application could be sent as an encrypted request, and in response to reception of the QR code fill request from the application, the server can, decrypt an encrypted QR code fill request via a shared key; determine a QR fill code based on a payload included in the encrypted QR code fill request; and transmit a QR fill code to the electronic gaming terminal.

Various additional aspects, features and advantages of fill generation systems and methods of the present disclosure described herein and embodiments thereof will be apparent from the following Detailed Description and the accompanying Drawing Figures. Moreover, it is to be understood that both the foregoing information and the following detailed description provide merely illustrative examples of various aspects and embodiments and are intended to provide an overview or framework for understanding the nature and character of the claimed aspects and embodiments. It further should be appreciated that this disclosure may be readily utilized as a basis for modifying or designing other structures for carrying out the same purposes as the disclosed embodiments, and that such equivalent constructions do not depart from the spirit and scope of the principles disclosed herein. Accordingly, these and other aspects, along with advantages and features of the present disclosure, will become apparent through reference to the following description and the accompanying drawings.

### BRIEF DESCRIPTION OF THE DRAWINGS

The accompanying drawings, which are included to provide a further understanding of the embodiments of the present disclosure, are incorporated in and constitute a part of this specification, and illustrate various example embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale, and various features and elements shown in the drawings may be expanded or reduced to more clearly illustrate embodiments of the disclosure.

FIG. 1A depicts an example of a gaming terminal.

FIG. 1B an example embodiment of controls of an electronic gaming terminal in accordance with the principles of the present disclosure.

FIG. 1C depicts one example embodiment of a fill generation system for enabling enhanced fill requests in accordance with the principles of the present disclosure.

FIG. 1D depicts another example embodiment of a fill generation system for enabling enhanced fill requests in accordance with the principles of the present disclosure.

FIG. 1E depicts yet another example embodiment of a fill generation system for enabling enhanced fill requests in accordance with the principles of the present disclosure.

FIGS. 2A-E shows an example embodiment of a graphical user interface to fill a gaming terminal in accordance with the principles of the present disclosure.

FIG. 3 is a flow diagram of an example process for executing a fill operation for a gaming terminal in accordance with the principles of the present disclosure.

### DETAILED DESCRIPTION

Embodiments of the present disclosure are directed to fill management system 100 and methods configured to provide a secure and easy to use method/system for the supply/re-supply of “fills” for continued plays or games using an amusement or gaming system, machine, or terminal 102 (hereinafter referred to as a “gaming terminal”) that facilitates play of electronic games that allow players to spend money and win awards including money, prizes, credits, or other rewards. In embodiments, the gaming terminal can be configured play of a variety of electronic games. For example, in some embodiments such games can include “skill games,” where by players can win the game by exercise of skill and/or chance, and based on a selected fill amount for that gaming terminal, win/obtain awards greater than a player's amount wagered or spent through the exercise of such skill and/or by chance. Effectively, in an embodiment, a player's ability to win a prize or award may be dependent on their exercise of skill, for example, learning and executing rules, patterns, and other features of the game as opposed to random chance. Other games may utilize some combination of skill and/or chance, while other games may utilize chance only.

Game (gaming) systems and/or devices (e.g., gaming terminals), capable of awarding monetary value and even if predominantly skill, may be regulated to assure fairness for both the player and the operator. For example, with respect to hardware and software for such gaming systems, the components which run the game engine of the gaming systems/devices (that is, implement the software instructions for playing an electronic game, including, in some embodiments, an RNG and programing in order to execute the game play instructions according to the game rules, to generate game outcomes) are subject to considerable scrutiny for business viability. In many instances, such gaming devices may be monitored by a federal, state, and/or local government agencies. For such a gaming terminal, the fill amount or number of “plays” available to players may be regulated and, thus, tracked, such as for tax purposes. In other embodiments, the fill amount or amount of plays on a gaming terminal may be monitored and/or updated or “filled” via a gaming terminal operator or account management system.

Accordingly, the present disclosure provides specialized hardware, firmware and/or software that may be implemented in gaming devices and/or gaming servers that differs from general purpose computers to adhere to strict regulations and/or strenuous conditions while further enabling the secure and efficient implementation of fills on client (e.g., operators, players, distributors, or other users) gaming systems/devices. Utilizing one or more general purpose computers is not suitable for use within gaming terminals as utilized in the fill management system such as described herein. This is due to a) potential regulatory requirements for gaming systems, b) strenuous ambient conditions of operation, c) verification and security requirements, d) game recovery and fault tolerance requirements and/or e) specialized hardware and software. For example, the terminals herein may be implemented as state machines. In such state machines, the terminal generally returns to its last state (e.g., at a specific point of a game in progress) if encountering a power interruption, electrostatic discharge, etc. once power is resumed. This is unlike a general purpose computer, is accomplished with specialized hardware, firmware and/or software and may be required due to regulatory or business considerations.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

In general, the term “user” can refer to an operator of the terminal (e.g., an owner of a gaming terminal or a location at which one or more gaming terminals are located and in use).

The term “fill” can refer to a fee (e.g., a license fee) or other credit enabling plays of game on an electronic gaming terming. In embodiments, a “fill amount” or “play,” as used herein, generally refers to the fill amount or amount of fill remaining on the game terminal. The terms “fill amount” or” play” may be used interchangeably with the terms “play amount,” “play level,” “total plays,” or “plays remaining.” The amount or value of plays may be expressed as a percentage of a full fill. For example, a gaming terminal with a full fill may be represented as 1.0. In other words, the plays remaining on such a gaming terminal are 100%. In an embodiment, the plays may decrease or increase based on an amount of player wins. For example, if a player wins (in other words, if the gaming terminal provides increased payouts or experiences a loss in profit), then the number of plays available on the gaming terminal (or the fill amount) may increase. In such an example, the plays (or the fill amount) may exceed one or 100%. If a player loses (in other words, if the gaming terminal receives more from a player than the gaming terminal pays out or experiences an increase in profits), then the plays (or the fill amount) may decrease gradually until the plays (or the fill amount) reaches zero.

In an embodiment, the term “game credit” may refer to a number of turns a player has based on an amount paid and/or based on an amount earned. In other words, game credits are an amount of turns that a player may purchase and then use, while an “amount of plays” or fill amount, as described above, is an amount indicative of the total plays allowable on a particular gaming terminal. In embodiments, the number of game credits available to a player may be limited to the fill amount or amount of plays.

For purposes of illustration, and not limitation, embodiments of the gaming terminal 102 of the present disclosure will be described in connection with gaming terminals or devices that can be configured to provide one or more games that utilize a selected number of plays that are tracked by a governmental authority and/or gaming terminal operator. For example, a gaming terminal may include a selected number of total plays or fill amount. Once those plays have been played or once the fill amount has been exhausted, such that there are no more plays available at the gaming terminal for an account associated with the gaming terminal, an operator, distributor or an owner of the gaming terminal may initiate a fill request to add, increase, or re-fill the number of plays or the fill amount on the gaming terminal (in other words, a fill operation). In some embodiments, to ensure that the data transferred between the gaming terminal 102 and a fill generation system 106 or device is not intercepted, read/copied or otherwise utilized by a third-party, the gaming terminal and a fill generation system or device may encrypt any data prior to transmission of the request. Further, in some embodiments, the gaming terminals may or may not have access to reliable internet sources, in such embodiments, the fill operation process may utilize a process based on an internet connection and a process based on no or unreliable internet availability.

In embodiments, the fill management system 100 and methods of the present disclosure can be adapted to facilitate the case and secure requesting, validation, and re-supplying or updating of filled amount for continued game play at authorized gaming terminals. For example, in embodiments, the current disclosure provides improvements to the current process or renewing or obtaining fills by enabling internet based fills that can occur with limited to no user interaction (for example, via an operator selecting a fill operation via a selectable button on a gaming terminal or on a touch enabled screen). In various embodiments, the present disclosure is directed to a fill management system 100 and methods of operation thereof, for securely providing fills to a gaming terminal 102 in communication with the file management system and which can do so with minimal action required from the operator once a fill request is initiated.

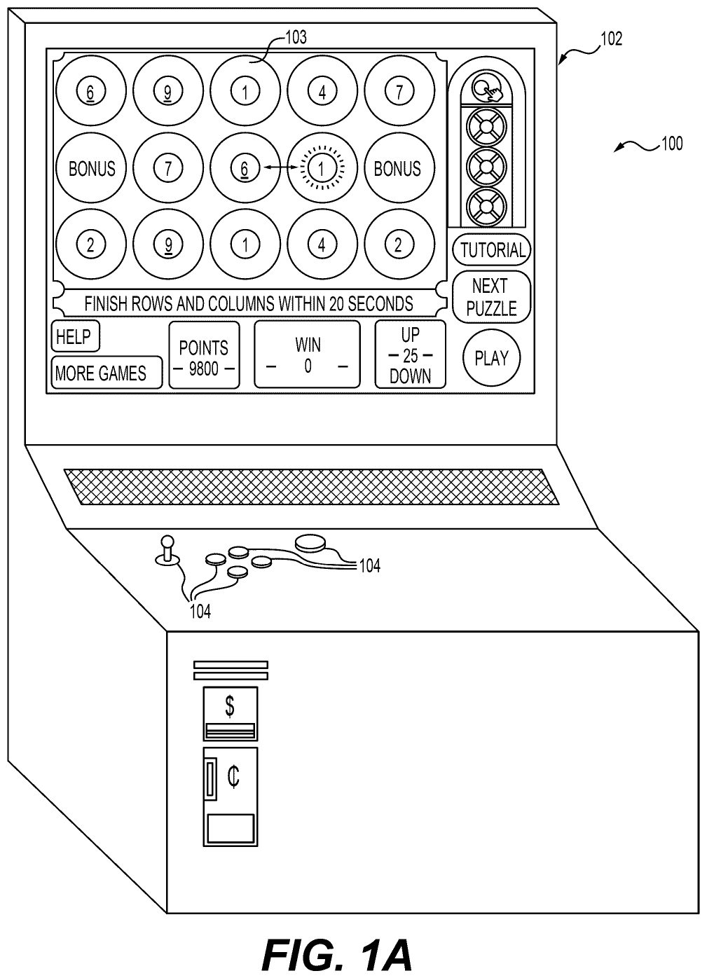

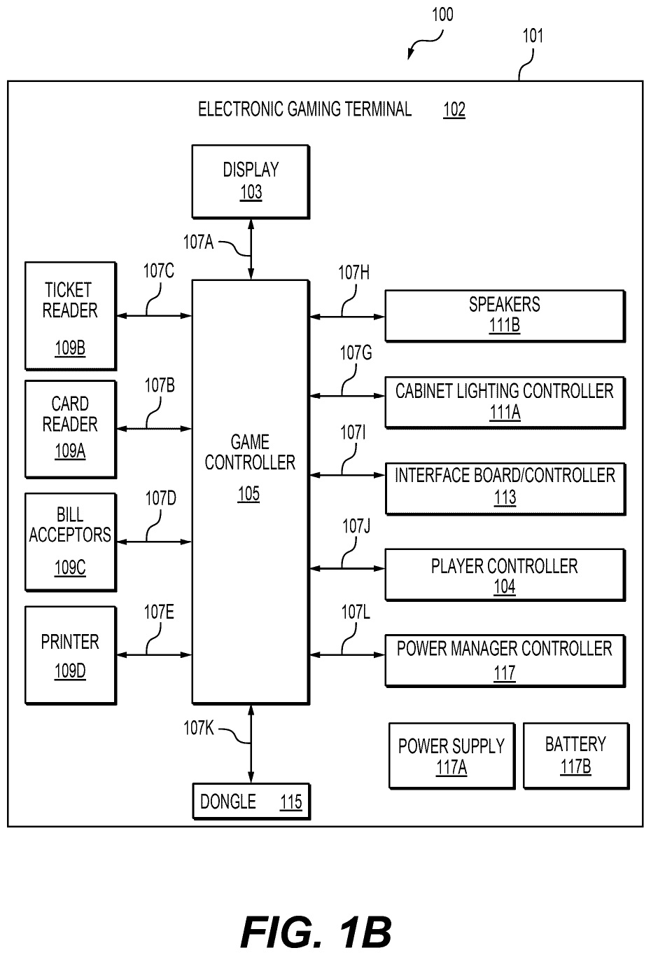

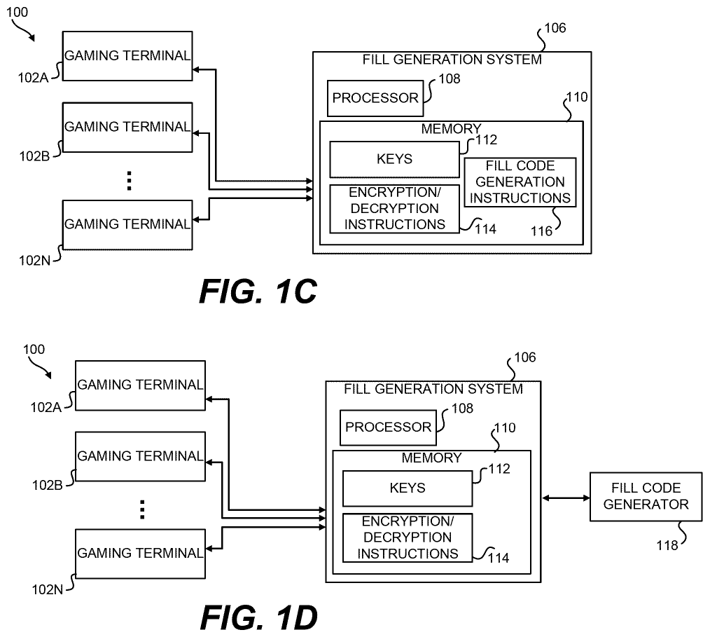

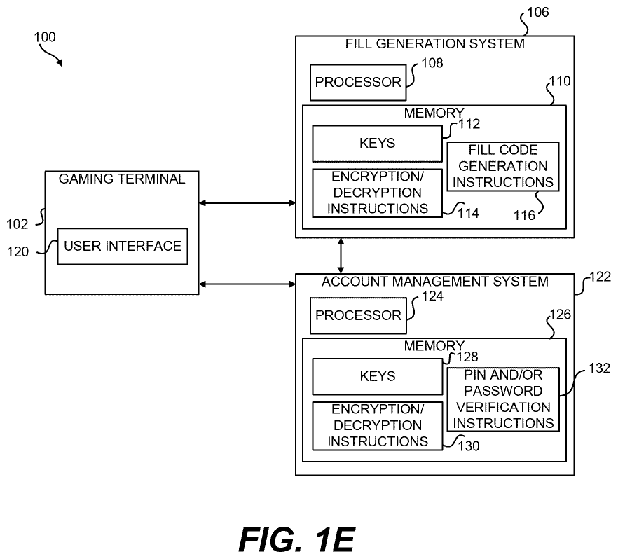

In embodiments, as illustrated in FIGS. 1A-3, the gaming terminal 102 (or each of a plurality of gaming terminals 102A, 102B, . . . 102N) can comprise one or more electronic games (which could include various types of electronic games, including, for example, skill-based games, games of chance, or game using some combination of skill and/or chance) that utilize a number of game plays or a fill amount available at that specific gaming terminal. It will be understood that while the present disclosure describes the use of the fill management system and methods in one example embodiment including a skill-based game, the systems and methods of the present disclosure are not limited to use with skill-based games.

In some embodiments, the gaming terminal 102 (FIG. 1A) can include a gaming cabinet or housing 101 that supports a display 103 (for example, a flat panel display or monitor) with a screen for display of one or more game fields and/or images and for supporting play of one or more games, and one or more sets of player controls 104. The games may be playable for the amount of plays or fill amount currently available for that gaming terminal. Thus, a first player may not completely exhaust the amount of plays or fill and a plurality of players may utilize the gaming terminal until the amount of plays or the fill amount available at the gaming terminal is exhausted.

In addition, in some embodiments, the fill management system 100 and methods may also be utilized with and include remote gaming systems, such as in an online gaming environment. In a gaming system operable in an online gaming environment, the gaming system can include a gaming engine that may be executed on the game server (e.g., a thin client embodiment). In a gaming system within a brick-and-mortar casino, the engine may be executed on the gaming terminal (e.g., a thick client embodiment). Still further, the fill management system 100 and methods also are configured to be operable with other types of gaming devices, such as remote or mobile devices including, but not limited to, devices such as a smart phone, tablet, desktop, laptop or computing device, in communication with a game server.

The gaming terminals and other gaming systems (e.g., mobile devices, etc.) may include communications between a game server and one or more of a controlling server, accounting server, history server, fill system and/or server. Game outcomes may be generated on a game server and transmitted, directly or indirectly, via a network, to one or more remote devices, gaming terminals, etc. which display results to players. In embodiments, where a player is playing on a remote (e.g., mobile) device, this remote device can act as a client, and may utilize encrypted communication with the game server in a “thin client” configuration via the world wide web. The player's remote device may utilize geolocation data in conjunction with device geolocation functionality to determine geographic location and transmit this information to one or more servers to verify the player is within a defined regulated jurisdictional area. The player's device may utilize a rechargeable power source, such as a rechargeable battery.

In some embodiments in which a gaming system includes a gaming terminal or remote device in combination with a central game server (or controller or remote host), the server will comprise a suitable computing device comprising at least one processor and at least one memory or data storage device. In such embodiments, each of the server and gaming device controller or processor(s) is configured to execute, transmit and receive data, or cause the same thereof, representing events, commands and gaming system and/or game related information. A subset of functions of the server may be conducted by the terminal, and vice versa. Instructions for controlling the games displayed by the device may be executed by the server in a “thin client” arrangement, such that the server remotely controls the games as displayed on the device, and the gaming device in turn receives player input which is transmitted back to the server. Alternately, in a “thick client” arrangement, the device executes the instructions locally.

Once the plays or the fill amount loaded at the gaming terminal has been exhausted, an operator, owner, or other user may request a fill. A fill or fill operation includes the approval and addition of an additional amount of plays or a fill amount to the gaming terminal. The amount of plays is not necessarily limited to a specific number of games that can be played at the gaming terminal (e.g., the fill or play amount is not necessarily tied to a specific number of games, for example, 10, 50, 100, etc. to be played at the electronic gaming terminal), and instead can comprise an amount or percentage/portion of a fill. Typically, the operator or user would call a fill provider and provide information verbally to the fill provider to perform such a fill operation.

Further, in embodiments, for gaming terminals with limited to no internet access, an operator or other user may utilize an application on a mobile device or other computing device to perform the fill operation, along with a unique quick response (QR) code generated by the gaming terminal.

It will further be understood that, while embodiments of the present disclosure may be described in connection with the example of a single player cabinet game or touch screen type gaming device for play of games, it should be appreciated that embodiments of the present disclosure are not so limited. For instance, other types of computational devices, such as mobile devices that, in some non-limiting embodiments, can include smartphones, tablets, laptops, Personal Computers (PCs), and/or wearable devices, may be used to implement game enhancement features as part of a game as described herein. Furthermore, it should be appreciated that embodiments of the present disclosure may apply to games other than slot-style games. For instance, embodiments of the present disclosure may be used in connection with any type of grid-based skill game such as bingo, keno, slots, matching games, table games, other types of skill-based games, and/or other types of skill and/or chance based games.

In one embodiment, the gaming terminal or gaming terminals 102 can include a centralized or host control system (e.g., a game controller 105) having one or more processors (for example, microprocessors, CPUs, and/or other processors) that is in communication with one or more individually connectable or linkable player controls or player stations, which each can have their own player station control systems, and which can have one or more processors in communication with the centralized control system. The player station control systems can communicate or cooperate with the centralized control system to send and receive instructions, feedback, workflows, and/or signals to facilitate game play and other functions of the gaming terminal. Each of the player station control systems generally controls and provides processing of one or more actions of its corresponding game controls and monetary interface peripherals, as well as the audio and lighting features of the player station. The player station controls also can provide tactile or haptic feedback during game play.

The centralized control system and the player station control systems access, run, and coordinate action of one or more actions or components of a gaming platform that provide for play of one or more games with the gaming terminal. The gaming terminal further can include or provide games with, in some embodiments, prescribed operations or patterns incorporating a series of learnable skill applications/features (e.g., “skill games”). The games also can include an environment of changing screens, colors, characters, elements, and/or features which can provide the appearance/randomness of randomness, but also include rules and identifiable patterns that a player can learn or strategize against to develop their skill and ability at playing the game to consistently attain awards greater than the amount the player has spent (or a greater than 100% Return to Player (“RTP”)). As noted, a gaming terminal may provide other games that incorporate some combination of chance and/or skill.

The centralized control system can include one or more processors (including microprocessors, CPUs, and/or other processors), and one or more memories (including ROM, RAM, and/or other non-volatile memories) that store instructions, including game rules, fill operations, and/or instructions and other programming, that when accessed and executed by the one or more processors facilitate game play, fill or play updates, and other operations/functions of the gaming terminal.

In some embodiments, the gaming terminals, may comprise a memory. In embodiments, the memory of the gaming terminals can comprise RAM, storage media, non-volatile memory, one or more EPROMs, EEPROMs, hard drives, solid state drives, flash memory, one-time programmable chips, OptionROM, BIOS, etc. In some embodiments, such memories may also include memory utilizing battery-backup or other non-volatile memory as may be required by regulations.

In one example embodiment, a centralized control system can include a centralized PC system controller with at least one processor and a memory; however, other suitable computing hardware can be used without departing from the scope of the present disclosure. A centralized control system further can include a graphics adapter, or a connector configured to accept a graphics card. Still further, a centralized control system can include one or more hubs, such as one or more USB port hubs that connect to one or more controllers or processors of a motherboard or game controller of the player station control systems.

In one embodiment, the gaming platform can provide a video playfield on the display of the gaming cabinet, which playfield is used by one or more players (e.g., accessing the controls of a corresponding player station) to compete for awards or prizes that are made available over time and for an amount of plays on the gaming terminal. The actions of playing for such awards and prizes include a plurality of repetitive motions and/or pattern recognition that can be learned, recognized and anticipated by player skill and experience.

In embodiments, the gaming terminal also can include one or more gaming platforms or gaming programs that include programming or instructions for one or more skill-based games. The gaming platform can include computer programs instructions, workflows and/or code that are accessed and executed by the processors to facilitate play of the one or more skill-based games with the amusement system. In additional or alternative constructions, the gaming platform(s)/program(s) further can be accessed and/or run on one or more personal electronic devices, such as smart phones, tablets, personal computers, and/or other mobile electronic devices, to facilitate play or operation of the one or more skill-based games on the personal electronic devices.

In one embodiment, the personal electronic devices can be provided at a facility (for example, amusement center, gas station, grocery store, airport, and/or other similar locations) and accessed by players for play of the one or more games. In other embodiments, players could be enabled to access and/or download the gaming platform(s)/programs (such as from an application store, for example, Apple Store®, Google Play® store, and/or from an available public or private network) to their own personal electronic devices for play of the one or more skill-based games therewith. In some embodiments employing personal electronic devices, the player controls can be provided as selectable icons or areas shown on the display of the personal electronic devices and/or can include physical controls of the devices themselves and/or remote controls in communication therewith.

In embodiments, the gaming platform can provide one or more substantially true skill-based games whereby, players generally can control decisions as to whether or not to take specific actions (for example, direct objects, initiate game plays, set play costs, and/or make selections, among other actions) at any particular time and player skill abilities and/or player strategy determine immediate and long-term outcomes. In embodiments, the various aspects of the game that affects the ability of a player to win and be awarded an award or prize are not controlled by or RNG driven, and may not include background code runs (for example, compensating algorithms) that calculate and/or artificially limit the return to a player and/or make it difficult for players to attain awards or prizes regardless of their skills. In embodiments, the gaming platform also can include programming requiring interaction and the application of the player to obtain awards or prizes, while the prizes and/or timing of an availability of some prizes can vary.

Among other things, embodiments of the present disclosure include games that provide a player with more ways to win a game, the ability to alter the chances of winning in a game, the ability to alter the payout amount for a winning game outcome (for example, through a bonus round or match), and add excitement to the overall game-playing experience of skill games.

In yet other embodiments, and as noted herein, the gaming terminal or system may provide games that utilize some combination of skill and/or chance.

With reference now to FIGS. 1C-1E, illustrative example embodiments of the fill management system 100 including a computational device that may be used to implement a game or the like and a fill operation to fill plays will be described in accordance with at least some embodiments of the present disclosure. For example, a series of gaming terminals 102A . . . 102N can be linked to the fill management system 100, and, in some embodiments, can comprise a gaming terminal 102 as shown in FIG. 1A, or, in other embodiments, may include a portable or non-portable devices used for executing a gaming application or multiple different gaming applications without departing from the scope of the present disclosure.

While a device may be described as non-portable, it will be understood that such a device may not be considered fixed. Non-limiting examples of a gaming terminal include an electronic gaming machine (EGM), a Video Gaming Machine (VGM), a mobile communication device (e.g., a smartphone, laptop, tablet, and/or wearable device), and a personal computer (PC).

In addition, in some embodiments, a gaming terminal 102 may be included in a system that may include one or more external servers (for example, a casino player tracking server, a ticket-in-ticket out server, a progressive system server or controller, a casino management system server, a central or game server, fill system, etc.). In such embodiments, one or more gaming terminals may be operably connected to the one or more external servers and can be operated as part of a larger gaming platform, such as part of a multi-player gaming system or platform. In such embodiments, the gaming terminals may afford players and operators the opportunity to utilize functionality implemented on and/or display data located on one or more of the servers.

In embodiments, the gaming terminals 102A, 102B, and up to 102N of FIGS. 1A-1E may include a support structure, housing, or cabinet 101 which provides support for a plurality of displays 103, inputs, a user interface or player controls 104 and other features of a conventional gaming machine as shown in FIG. 1A. For example, in the illustrated embodiment, a player can play or operate one of the gaming terminals 102A, 102B, and up to 102N, which may be configured as a physical or stand-alone type of gaming system/terminal such as shown in FIG. 1A, wherein the gaming terminals 102 can utilize a cabinet design including a cabinet 101, in which one or more displays 103 are located, and which will house mechanical and control components of operation of the gaming terminals (e.g., playing games, determining and dispensing prizes or award, communicating with the fill generation system 106 (FIGS. 1C-1E), generating reports, etc.). Additionally, while an example embodiment of a gaming terminal with a cabinet, display screen and controls is shown in FIG. 1A, it will be understood that this is only one example, and the gaming terminals 102 also can be constructed with varying cabinet and display configurations. For example, in other embodiments, the game terminals can be constructed or positioned, alternatively (i) on a base or stand, (ii) configured as a pub-style table-top game (e.g., where the participant computational devices are located remotely from a shared game controller or central server/control, as discussed below), (iii) as a stand-alone computational device on the floor of a casino with other stand-alone computational devices, or (iv) in any other suitable manner.

As further indicated in FIG. 1B, in embodiments, the gaming terminal cabinet 101 may also internally house a game controller 105 that will be operably connected to the mechanical and control components of the gaming terminal 102. For example, the game controller 105 can include one or more processors (e.g., including one or more processors arranged on a motherboard) and can be configured with programming designed to run a game engine (e.g., implement instructions or commands for executing play of one or more electronic games, and which, in some embodiments, may include an RNG, to generate a game outcome for the plays thereof). In embodiments, the game controller 105 further may be connected, such as via one or more device drivers (indicated at 107A-107J), to one or more displays 103 (e.g., a primary display and/or a secondary display), to input/output devices such as a card-reader 109A, ticket reader 109B, bill validator (BV) 109C, such as a printer 109D, to player controls 104, which, in embodiments, can include a touch-screen input, input button(s) or joystick(s), button display, player-tracking display, or combinations thereof, to controls for cabinet lighting 111A and speaker(s) 111B, to an interface board controller 113 including software and/or money fill data, a dongle 115 containing firmware and/or software, and, in some embodiments, to a slot-machine interface board (SMIB), a power management system 117 that can regulate power from a source such as a power supply 117A or a battery 117B, switches, as well as other components, such as cabinet security sensors and internal CPU box sensors. Various other hardware or operational components and/or drivers also may be operably connected to the game controller 105.

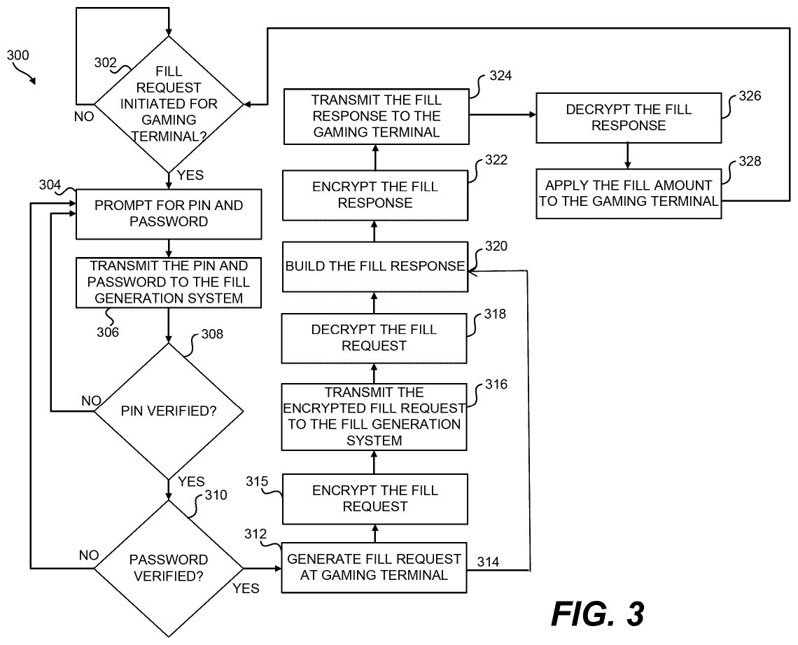

In addition, in embodiments, the gaming terminal can include hardware and/or drivers configured to provide security against improper and/or the absence of external hardware and/or sensor data, which may cause the gaming terminal to become inoperable to players. For example, a hardware device, such as a dongle 115 that can interface with the game controller 105 (e.g., via insertion through a corresponding input/port on the motherboard or I/O board) may be customized and can include dedicated software and/or firmware configured to provide such security. In embodiments, the dongle 115, for example, may be required during the boot-up process for the gaming terminal 102 to ensure (e.g., via hash codes which may be encrypted) the proper operating software (OS) and proper game software is initiated. In such a case, the lack of a dongle may cause the gaming terminal to suspend operation. In addition, in embodiments, the lack of a proper hash may also cause the gaming terminal to suspend operation. Still further, in embodiments, the lack of a dongle or lack of a proper hash can cause the gaming terminal to suspend operation. Such behavior ensures control over the application(s) running on the gaming terminal and is unlike that of a general purpose computer. Such a hardware device may additionally fulfill some or all of the functionality of the fill management system 100 on the gaming terminal side, as illustrated in FIG. 3, for example at steps 312, 315, 316, 326 and/or 328.

In addition, in embodiments, the gaming terminals, will include a memory accessible by the gaming controller. In embodiments, the memory of the gaming terminals can comprise RAM, storage media, non-volatile memory, one or more EPROMs, EEPROMs, hard drives, solid state drives, flash memory, one-time programmable chips, OptionROM, BIOS, etc. In some embodiments, such memories may also include memory utilizing battery-backup or other non-volatile memory as may be required by regulations.

In some embodiments, the gaming terminals 102 or other gaming platform(s) or/system(s) may employ a selected set or pool of awards, progressive awards, prizes, bonus awards, or other game outcomes that can be achieved by a player (e.g., awards that can be based on a level or amount of a play of each game). As each award or other game outcome is provided to the player, a provided award or other game outcome can be marked as being awarded and/or, in some embodiments, can be removed from the predetermined set or pool. The gaming terminals 102 generally can be configured to provide players with all of the available awards or other game outcomes over the course of the play cycle, for a selected number of plays, that can be limited to an available fill amount, and which, in embodiments, can vary according to a remaining fill amount at the game terminal.

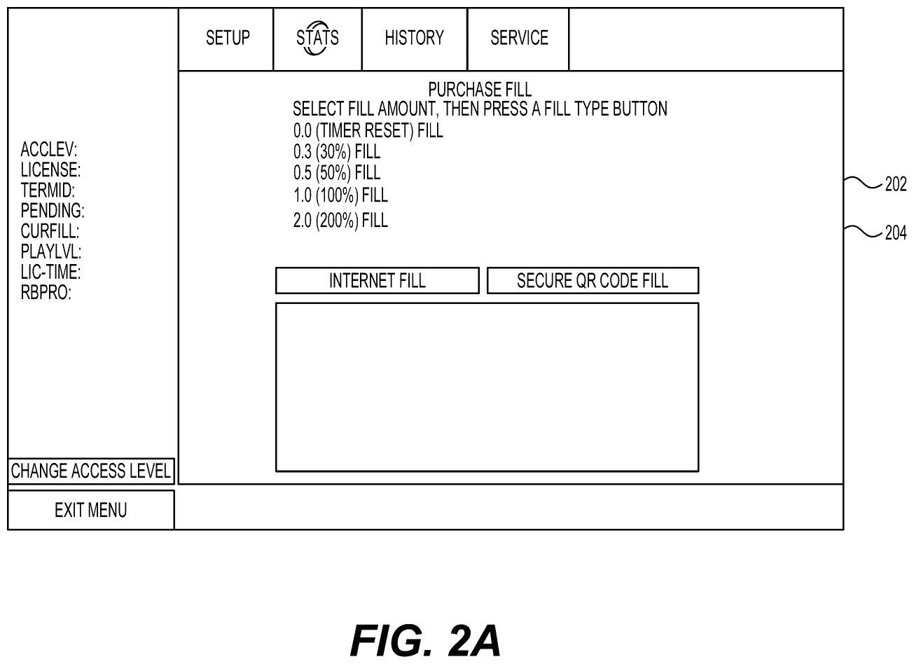

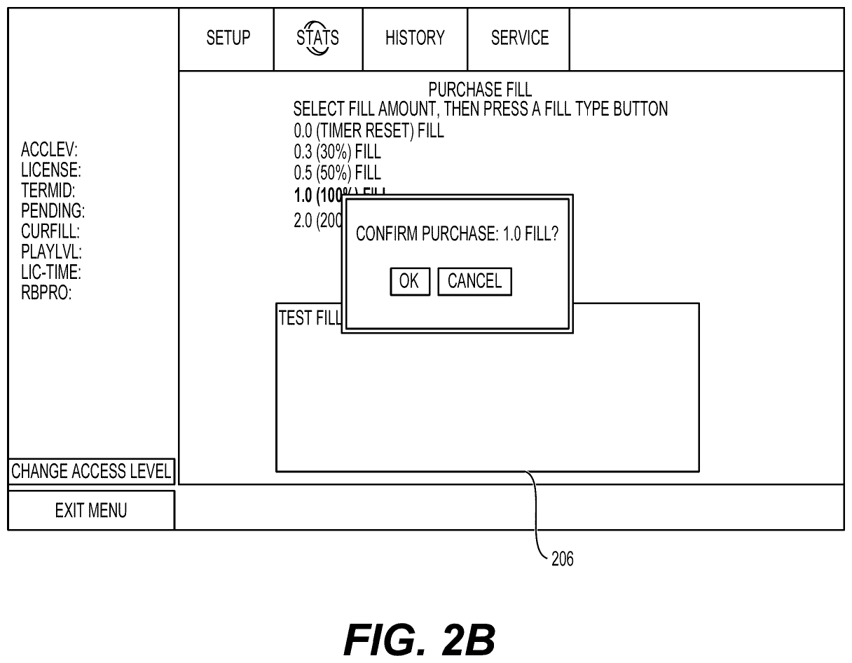

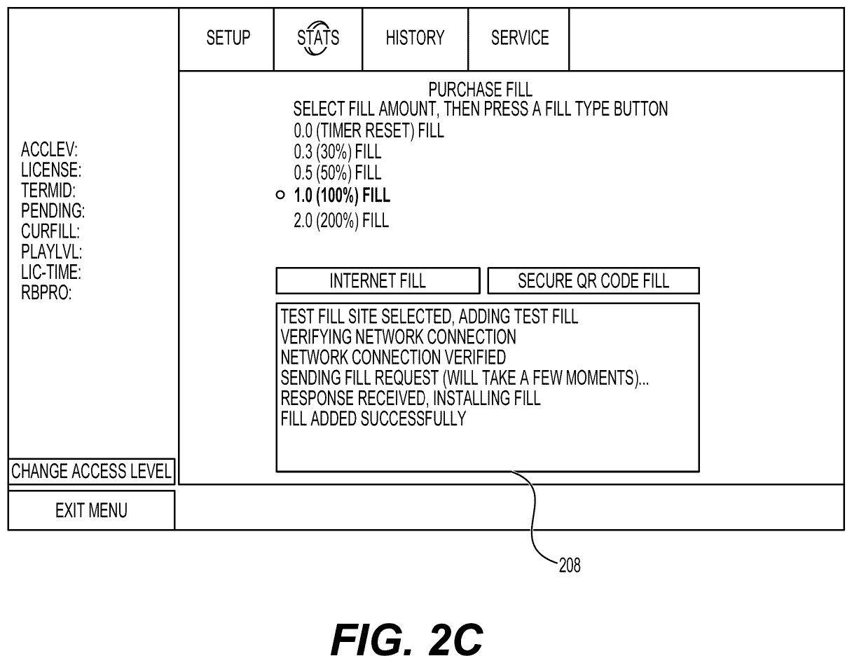

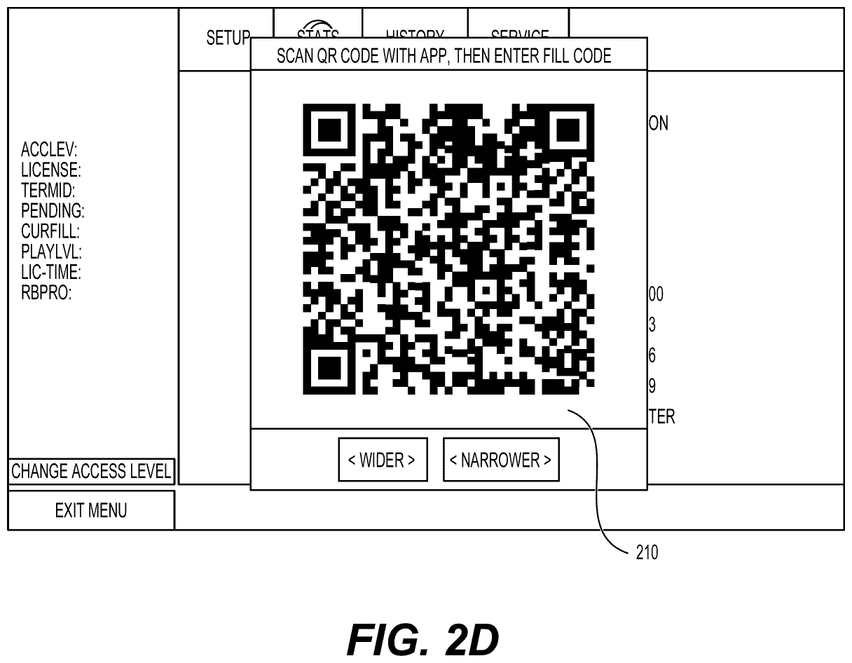

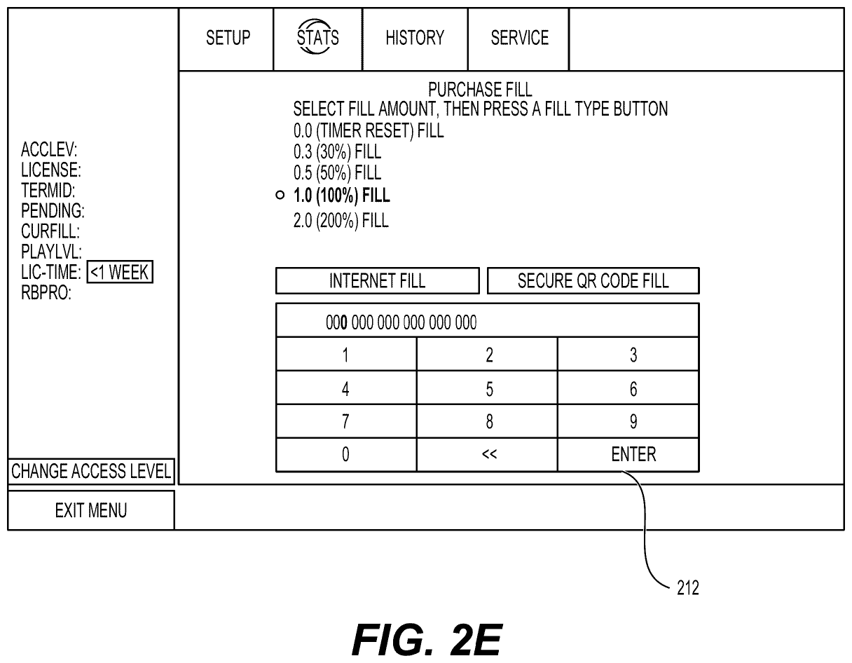

As noted, the gaming terminals 102A, 102B, and up to 102N may include a display 103 on which a game or play field is presented. In addition, the display can be used to access and/or display a menu with various control or setup screens, including screen(s) displaying the number of plays or fill amount remaining for each game terminal or a series or limited game terminals, such as shown in FIGS. 2A-2E. Once a number of plays or the fill amount is exhausted, the gaming terminals and/or an operator, owner, or other user may request a fill or, in other words, additional plays. In another embodiment, the gaming terminals can include programming configured such that the gaming terminal may transmit a fill request to the fill management system 100, for example being transmitted a fill generation system 106 (as illustrated in FIG. 1C-1D) and/or an account management system 122 (as illustrated in FIG. 1D).

In an embodiment, the gaming terminals 102 may connect to the fill generation system 106 via the account management system 122. In yet another embodiment, the transmission of data between the gaming terminals 102, the account management system 122, and the fill generation system 106 may occur via one of a REST interface, RESTful interface, a power on self-test interface or method, an xml-based protocol (such as Simple Object Access Protocol (SOAP)), or sockets, and/or via other communication protocols or methods, as will be understood by one skilled in the art.

The fill generation system 106 may include a processor 108 and a memory 110 storing instructions executable by the processor 108. In embodiments, the fill management system 100 will include the fill generation system 106 and an account management system 122 linked to one or more game terminals, such as indicated at 102A, 102B, and up to 102N in FIGS. 1C-1D. In some embodiments, the account management system 122 may be included in the systems described herein (e.g., the account management system can be incorporated within or as a part of the fill generation system such as being on a same server). In some embodiments, the account management system 122 may be a separate system including a processor 124 and memory 126 storing instructions executable by the processor 124. In an embodiment, rather than including a separate account management system 122, as illustrated in FIG. 1E, the memory 110 also may include instructions implementing the functionality of the account management system 122.

Upon receipt of a fill request, the account management system 122 (or, in some embodiments, the fill generation system 106) may prompt, for example via execution of instructions 132, each of the gaming terminals 102 requesting a fill to provide authorizing credentials. In embodiments, the prompt can be a query or request sent by the account management system back to the gaming terminal once the fill request is initiated, without requiring further operator involvement. In other embodiments, once the fill request is initiated, the account management system can reply by sending back a prompt or request requesting the operator enter their credentials to verify the fill request.

Such a prompt, for example, may be displayed via user interface 120. In another embodiment, the fill request generated by the gaming terminals 102 may include the credentials, prior to transmission to any other component or device. In embodiments, the credentials may include a personal identification number (PIN) and/or account password. In an embodiment, the PIN may correspond to a specific gaming terminal or may correspond to each gaming terminal at a selected location. The account password may correspond to an operator's (or other user's) gaming account. Such an account may include data indicative of payment information for fills, as well as any other data relevant to fills. In embodiments, the fill generation system 106 and/or the account management system 122 also may include an algorithm (see 132) to verify the authorizing credentials of the gaming terminal(s) submitting the fill request, for example, via comparison or searching from a list of pre-verified credentials (e.g., credentials identified or associated with of known operators, owners, and/or other users).

In some embodiments, once the operator enters the PIN and/or account password, the gaming terminals may transmit the PIN and account password to the corresponding requestor. In an embodiment, the communication between the gaming terminals 102 and the fill generation system 106 and/or the account management system 122 (e.g., the transmission of the PIN and account password and the initial fill request) may be encrypted. In such embodiments, the gaming terminals 102 may include an encryption algorithm. In embodiments, the gaming terminals 102 may include one or more private keys 112 and/or 128, and/or may utilize public keys as well.

Further, the fill generation system 106 and/or account management system 122 may include corresponding keys that can be associated with a particular gaming terminal or a series of gaming terminals associated with a particular operator and/or some public keys, along with one or more encryption algorithms or instructions (see 114 or 130). The encryption algorithms may include one or more public or private key-based encryption algorithm, as will be understood by those skilled in the art. Thus, prior to transmission of data between any device or computing device, the transmitted data may be encrypted and, upon reception, may be decrypted.

Once an account has been verified via the PIN and password, the gaming terminals 102 may transmit the fill request to the fill generation system 106. As noted, any transmitted data may be encrypted prior to transmission and decrypted upon reception (for example, via 114). Once the fill request is received, the fill generation system may determine or generate a fill code. The fill code may include a unique or random, one-time code for filling the gaming terminals 102.

In an embodiment, prior to determining or generating the fill code the fill generation system 106 may determine whether the requestor is able to receive additional plays or fill amount for a particular gaming terminal. For example, the operator's account, or any of the gaming terminals (e.g., terminals 102A, 102B, and up to 102N associated therewith, as indicated in FIGS. 1C-1D) may include a selected maximum fill amount that can be purchased for each of the gaming terminals (e.g., per transaction and/or per a time period such as a day, week, or other time period). Thus, if a threshold available fill amount (e.g., a maximum amount available to the operator, or based on some other limit) has been reached for a particular gaming terminal, then no additional fills may be given.

Once a fill code is generated, the fill generation system 106 may encrypt the fill code and provide or transmit the encrypted fill code to the gaming terminal 102 associated with the fill request.

It will be understood that the process or actions described herein may be performed via an internet connection with limited to no human interaction. However, in some embodiments, the location where the gaming terminal(s) reside may have limited internet access. In such embodiments, the gaming terminals 102 may be configured to generate a unique QR code for creating and initiation a fill request. A user or operator may scan the QR code to begin the process described herein. Thus, an operator may initiate the fill operation even without internet access.

In an embodiment, initiation of the fill operation may occur based on the operator input and/or, in some embodiments, based upon some condition at any gaming terminals 102. For example, if the number of plays or fill amount is below a selected threshold, then the gaming terminals may initiate a fill operation.

In FIGS. 2A-2E, illustrative embodiments of a fill operation are shown. As noted above, a gaming terminal may include a user interface. When a gaming terminal reaches a selected number of plays or fill amount, or when the user or operator activates or submits a prompt therefor, then the gaming terminal may begin a fill operation. As illustrated in FIG. 2A, the gaming terminal may display an internet fill button 202 and a secure QR code fill button 204. In an embodiment, one or the other button may be displayed. In yet another embodiment, the button displayed may be dependent on one or more factors, such as internet access. Further, the screen may display a selectable amount of a fill, such as 30 percent, 50 percent, 100 percent, and/or 200 percent. Other percentages may be listed. In another embodiment, a blank form may be included that enables the operator to enter a custom fill amount. In another embodiment, the screen may display a timer reset fill. In such an embodiment, if selected, then a fill may occur after a selected time frame. In other embodiments, a threshold fill may be displayed, enabling the operator to select an amount of current plays that cause a fill operation to begin.

Once a type of fill is selected, a confirmation screen 206 may be generated, and can be displayed on the display of the gaming terminal as shown in FIG. 2B. In another embodiment, a credential entry screen may appear, prompting the operator to enter a PIN and account password to enable confirmation that the request to initiate the fill operation, and, in embodiments, confirmation that the fill amount requested is authorized.

As noted, the fill operation may occur with little to no operator interaction. The operator may, in some embodiments, select an amount and a type of fill, and then the fill may occur (such as via the methods or processes described herein). As illustrated with FIG. 2C, if an internet fill is selected, then the fill operation may proceed as described herein. The text box below the button (see 208) may display the current steps being performed.

In another embodiment, a user of the fill management system and/or a fill application (e.g., an operator, owner, or other user) may select a fill via a QR code or the gaming terminal may not include an internet fill option. In such embodiments, upon selection and/or based on some other factor the gaming terminal may produce or generate a unique QR code 210 as illustrated in FIG. 2D. In embodiments, the QR code 210 may be different each time a fill occurs. In another embodiment, the display or screen may include buttons enabling the user to increase or decrease the size of the QR code 210. The user may scan the QR code with another computing device, such as a mobile device, for example a smartphone or tablet. After the process described herein completes, another computing device may display a unique fill code. The screen, as illustrated in FIG. 2E, may generate a screen with a fill code entry panel 212.

With reference now to FIG. 3 a flow diagram depicting an example embodiment of a method for enabling a fill operation is shown in accordance with embodiments of the present disclosure. The methods described herein may be run as a set of instructions of the fill management system 100 and/or some other server in communication with the fill management system 100. In some embodiments, the set of instructions may be part of an application installed on the any component of the fill management system 100.

At block 302, the fill management system 100 may initiate a fill request or operation. Such an initiation may occur via the gaming terminal and/or via another separate device. For example, a separate computing device may manage fill operations for all gaming terminals at a selected location. Such a computing device may be utilized to initiate a fill operation. In another embodiment, fill operations may be initiated based on some condition set by the fill management system 100, such as an amount of plays left for a gaming terminal and/or after a selected time period or timeframe.

If a fill request or operation has been initiated, then, at block 304, an account management system and/or the fill management system 100 (which, in some embodiments can include or be part of at least in part, the account management system) may prompt the operator for a PIN and account password. The prompt may be displayed via the screen of the gaming terminal and/or via a separate computing device configured to manage multiple gaming terminals. In an embodiment, no prompt for credentials may be issued, rather, the gaming terminal may store such credentials and automatically provide such credentials after or as a fill request is initiated.

At block 306, the gaming terminal or other computing device may transfer the credentials to the account management system of the fill management system. In an embodiment, prior to transmission, the credentials may be encrypted.

At block 308, the account management system may verify the PIN. Such verification may include looking up the PIN in a database or comparing the PIN to a known PIN corresponding to an operator, owner, or other user.

At block 310, the account management system may verify the password. Such verification may include looking up the password in a database or comparing the password to a known password corresponding to an operator, owner, or other user.

At block 312, upon verification of the credentials, the gaming terminal or other computing device may generate the fill request. The fill request may include an amount of plays to add to the gaming terminal, as well as other information or data, such as a location of the gaming terminal, a type of the gaming terminal, the games on the gaming terminal, and/or the plays per each game, among other data.

At block 314, the authorized fill request from the gaming terminal or other computing device will be transmitted/forwarded to the fill generation system.

In some embodiments, (e.g., as indicated at 315-316) the fill request may be encrypted before being transmitted to the fill generation system. In embodiments, such an encryption may be based on pre-shared private keys, a combination of private and public keys, and/or based on some other encryption key. Once encrypted, at block 316, the encrypted fill request may be transmitted to the fill system. At block 318, the fill generation system may decrypt the fill request.

At block 320, the fill generation system may build a fill response. The fill response may be based on one or more factors, such as the fill amount requested, user, owner, or operator account data, funds associated with the user, owner, or operator, and/or previously used plays for a selected time frame, among other data.

In some embodiments, the fill generation system may encrypt the fill response, such as indicated at block 322; while in other embodiments no additional encryption may be provided. As further indicated at block 324, the fill generation system will transmit the constructed fill response directly to the gaming terminal and/or other computing device from which the request originated.

In some embodiments, if the fill response has been encrypted, as indicated at block 326, the gaming terminal and/or other computing device will decrypt the fill response, for example, using a key or other identifying code existing at the gaming terminal and specifically associated therewith.

In other embodiments, the fill generation system can send the fill response to the gaming terminal or other computing device without a separate encryption. For example, the fill request can be sent in a format configured to enable downloading of the fill response (including a fill code) directly to the gaming terminal or other computing device associated with the authorized operator account or the specific fill request sent.

Thereafter, as shown at block 328, the gaming terminal and/or other computing device may apply the fill amount to the gaming terminal.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure can include: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines (EGM), and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

A central server, central controller, or remote host and an EGM (or personal gaming device) can be configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

Moreover, as discussed, the hardware and/or software within a gaming system, including that running the game engine of the gaming system, may be required to adhere to various requirements such as, for example, regulations and/or market conditions that may require a secure-boot via a chain-of-trust, to ensure no unapproved hardware or software is present. According to some aspects of the present disclosure, that may occur, for example, via a hash algorithm such as SHA-1 first generating a BIOS value from the BIOS chip and verifying this value by comparison to a known value stored elsewhere, and next, via a hash algorithm generating a hard drive/SSD value for each executable file and verifying these values by comparison to known values stored elsewhere, checking via hash subsequent hardware firmware/drivers, etc. In this manner the software running the game engine may be static and unchangeable. Furthermore, the processor of the gaming system/terminal may be configured to continuously monitor all running processes and compare such processes to a “whitelist” of approved (authorized) processes, shutting down the system in the case of an unauthorized process. The hardware and software can function as a state machine, able to return to any previous state, either upon reboot, power interruption or system failure.

In addition, in case of customer dispute, or by regulation, the game system/terminal must be able to recover a prescribed number (e.g., 10 or 50) of last game plays, including any features or bonuses that may have been triggered. In so doing, the game controller of the gaming terminal generally will save (to non-volatile memory) all necessary attributes of each game result, and may verify (e.g., via a CRC-16 algorithm) data integrity of previously played games. The gaming terminal may need to withstand repeated power cycling. Indeed, many faults tolerated in a general computing device, such as software bugs that lead to a device hanging or crashing, hardware failures, overheating, etc., are not acceptable in a gaming terminal due to regulatory rules or, from a business perspective, the ensuing loss of revenue. Many conveniences, such as installing new software, updating software, reading from a USB drive, facilitating device connectivity, etc., which are the norm on a general computing device, may also be forbidden in the electronic gaming system/terminal environment, due to the strict security scrutiny of hardware, software and/or CPU processes. Furthermore, a gaming terminal controller or CPU will need to communicate with peripheral devices and/or features that are not found on general purpose computers, including for example, bill validators, ticket readers/printers, SMIB boards, cabinet lighting, topbox controller, fill system, etc. Furthermore, the gaming system/terminal may provide for regulators, at any time and unannounced, to have the ability to access and inspect the system and also run independent checks (such as on-the-fly hash function verification) that only approved hardware and/or software is implemented.

The foregoing are provided as non-limiting examples of attributes and features that may be found in the present system but not found on general purpose computers.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, and/or micro-code) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, or any suitable combination of the foregoing.

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

What is claimed is:

1. A method comprising:
initiating a fill request including a fill amount corresponding to a number of licensed game plays for play on an electronic gaming terminal;
in response to the initiation of the fill request, transmitting the fill request and an electronic gaming terminal PIN and an account password for an account associated with the electronic gaming terminal to receive the fill amount to an account management system;
verifying, via the account management system, the electronic gaming terminal PIN and the account password;
in response to verification of the electronic gaming terminal PIN and the account password by the account management system, transmitting the fill request and an identification of the electronic gaming terminal to receive the fill amount to a fill generation system;
building, via the fill generation system, a fill response including a fill code;
transmitting the fill response from the fill generation system to the electronic gaming terminal; and
upon receiving the fill response, confirming the fill code at the electronic gaming terminal and crediting the fill amount to the electronic gaming terminal.

2. The method of claim 1, further comprising encrypting the fill request prior to transmitting the fill request to the fill generation system; determining an encryption key; generating the fill code; encrypting the fill response prior to transmitting the fill response to the electronic gaming terminal; and applying the fill code at the electronic gaming terminal to decrypt the fill response.

3. The method of claim 1, wherein initiating the fill request comprises accessing a fill request screen or button at the electronic gaming terminal, selecting the fill amount, and confirming the fill request.

4. The method of claim 3, further comprising, in response to the fill request being sent to the account management system, generating a prompt for entry of an electronic gaming terminal PIN and an account password; wherein the prompt is transmitted from the account management system to the electronic gaming terminal; and wherein, in response to the prompt, sending the electronic gaming terminal PIN and the account password for an account associated with the electronic gaming terminal from the electronic gaming terminal to the account management system.

5. The method of claim 4, wherein after verifying the fill request, communication of the fill request is conducted between the electronic gaming terminal and the account management system, and communication of the fill response is conducted between the electronic gaming terminal and fill generation system substantially without human interaction.

6. The method of claim 1, wherein transmission of data between the electronic gaming terminal, the account management system, and the fill generation system occurs via one of a REST interface, RESTful interface, a power on self-test interface, an xml-based protocol, or sockets.

7. The method of claim 1, further comprising notifying the account management system that the fill response has been transmitted to the electronic gaming terminal and verifying a successful receipt and loading of the fill amount at the electronic gaming terminal by the account management system.

8. The method of claim 1, wherein the fill request includes a first plurality of characters, symbols, numbers, or combinations thereof, and the fill response includes a second plurality of characters, symbols, numbers, or combinations thereof.

9. A system for supplying fills for play of electronic games, the system comprising:
a fill management system in communication with at least one electronic gaming terminal;
wherein the at least one electronic gaming terminal includes:
a display configured for display of a play field for play of the electronic games and one or more control screens,
wherein the one or more control screens include at least one fill request screen, and
a processor including programming configured to enable an operator to access the at least one fill request screen and initiate a fill request for a fill for additional plays of electronic games at the electronic gaming terminal;
wherein the fill request includes a selected fill amount; and
wherein the fill management system comprises:
an account management system; and
a fill generation system in communication with the account management system;
wherein the account management system is configured to, in response the fill request:
generate one or more prompts for input of a personal identification number (PIN) for the electronic gaming terminal and an account password associated with the electronic gaming terminal;
verify the PIN and account password, and
in response to verification of the PIN and account password, transmit a verified fill request to the fill generation system;
wherein the fill generation system is configured to, in response to receipt of the verified fill request from the account management system:
build a fill response including a fill code, and
transmit the fill response to the electronic gaming terminal; and
wherein, upon receipt of the fill response from the fill generation system, the processor of the electronic gaming terminal is configured to recognize the fill code included in the fill response, and if the fill code is recognized, apply a fill amount for continued plays of electronic games at the electronic gaming terminal.

10. The system of claim 9, wherein the processor of the electronic gaming terminal further includes programming configured to generate a QR code; wherein the QR code includes the PIN and operator password associated with the electronic gaming terminal; and wherein when the QR code is scanned, a fill request initiated and transmitted to the account management system.

11. The system of claim 9, wherein the fill generation system is configured to encrypt the fill response prior to transmitting the fill response to the electronic gaming terminal; and wherein the processor of the electronic gaming terminal is further configured to decrypt the encrypted fill response using a key unique to the electronic gaming terminal.

12. The system of claim 11, wherein the fill request includes a first plurality of characters, symbols, numbers, or combinations thereof, and the encrypted fill response includes a second plurality of characters, symbols, numbers, or combinations thereof.

13. The system of claim 9, wherein the fill generation system is further configured to provide a response to the account management system indicating that a fill response has been sent to the electronic gaming terminal including the fill amount credited to the electronic gaming terminal.

14. A method of controlling fills of game plays at an electronic gaming terminal, the method comprising:
selecting a fill amount for additional game plays at the electronic gaming terminal and generating a fill request for a fill of the additional game plays at the electronic gaming terminal;
in response to the fill request, initiating a verification procedure including:
requesting a PIN and an account password associated with the electronic gaming terminal,
verifying association of the PIN and password with the electronic gaming terminal at an account management system, and
transmitting a verification from the account management system to the electronic game terminal to enable the electronic gaming terminal to proceed with submission of the fill request; and
transmitting the fill request from the electronic gaming terminal to a fill generation system,
wherein the fill generation system comprises at least one processor having programming configured for:
determining a fill response based on a selected fill amount in the fill request received from the electronic gaming terminal and a credit amount for an account associated with the electronic gaming terminal,
generating the fill response at the fill generation system, wherein the fill response includes a fill code and a return fill amount for enabling continued game plays at the electronic gaming terminal; and
encrypting the fill response; and
transmitting the encrypted fill response to the electronic gaming terminal via the account management system; and
applying the returned fill amount included with the fill response for continued game play at the electronic gaming terminal.

15. The method of claim 14, further comprising encrypting the fill request prior to transmitting the fill request to the fill generation system; determining an encryption key; generating the fill code; encrypting the fill response prior to transmitting the fill response to the electronic gaming terminal; and applying the fill code at the electronic gaming terminal to decrypt the fill response.

16. The method of claim 14, further comprising notifying the account management system that the fill response has been transmitted to the electronic gaming terminal and verifying a successful receipt and loading of the fill amount at the electronic gaming terminal by the account management system.

17. The method of claim 14, wherein generating the fill request comprises scanning a QR code using a mobile device; and wherein upon scanning the QR code, the fill request including the PIN and account password for verification of the fill request is automatically sent to the account management system.

18. The method of claim 14, further comprising encrypting the fill request prior to transmitting the fill request to the fill generation system, decrypting the fill request at the fill generation system, and encrypting the fill response prior to transmitting the fill response to the electronic gaming terminal.

19. The method of claim 18, wherein the encrypted fill request includes a first plurality of characters, symbols, numbers, or combinations thereof, and the encrypted fill response includes a second plurality of characters, symbols, numbers, or combinations thereof.

20. The method of claim 14, wherein initiating the fill request comprises accessing a fill request screen or button at the electronic gaming terminal, selecting the fill amount, and confirming the fill request.
